(19) United States
(12) Patent Application Publication
(10) Pub. No.: US 2015/0091705 A1
(43) Pub. Date: Apr. 2, 2015

(54) SYSTEMS, METHODS, APPARATUSES, AND COMPUTER PROGRAM PRODUCT FOR INVENTORY TRACKING AND CONTROL

(71) Applicant: McKesson Automation Inc., Cranberry, PA (US)

(72) Inventors: Ashley Banegas, Dallas, TX (US); Kevin Brown, Austin, TX (US); Greg Moore, Austin, TX (US); William B. Pattison, Mars, PA (US); Amirtha Raman, Seattle, WA (US); Jeffrey Thompson, Allison Park, PA (US); Celine Ramoni, Seattle, WA (US)

(73) Assignee: McKesson Automation Inc., Cranberry, PA (US)

(21) Appl. No.: 14/039,523

(22) Filed: Sep. 27, 2013

(51) Int. Cl. G06K 17/00

(52) U.S. Cl. CPC G06K 17/0022; G06K 2017/0051; G06K 2017/0045; G06K 2017/0083; G06K 2017/009
USPC 340/10.6; 340/10.1

(57) ABSTRACT

A system, method, apparatus, and computer program product are provided for tracking and controlling inventory with a container. A container that defines a cavity may include an access detection system configured to detect when the cavity of the container is accessed, a radio frequency identification reader configured to be activated in response to the access detection system detecting that the cavity has been accessed, and a communications interface configured to transmit a signal identifying the contents of the cavity in response to the radio frequency identification reader identifying a change in contents of the cavity. The container may also include a lid movable between an open position in which the cavity is accessible, and a closed position in which the cavity is inaccessible, where the access detection system is configured to detect when the lid is moved to the open position.

### TECHNOLOGICAL FIELD

Embodiments of the present invention relate generally to storing, tracking, controlling access to, and dispensing items and, more particularly, to systems, methods, apparatuses, and computer program products for providing controlled access to pharmaceuticals and medical supplies.

### BACKGROUND

Inventory tracking and control is used across a plurality of industries to manage costs, reduce shrinkage, dispense articles accurately, and to track item location. Inventory tracking and control is particularly important in a healthcare setting where inventory items, such as pharmaceuticals and medical supplies, may be expensive and potentially hazardous if not handled and dispensed properly. Accordingly, systems have been developed to assist in the proper tracking and control of articles in healthcare environments to increase safety, reduce costs, and to comply with state and federal regulations.

### BRIEF SUMMARY

Systems, methods, apparatuses, and computer program products are herein provided for tracking and controlling articles. Systems, methods, and apparatuses in accordance with various embodiments provide several advantages to conventional methods of tracking and controlling articles, particularly in a healthcare environment. In this regard, some example embodiments provide a system for tracking, controlling, monitoring, and auditing the flow of inventory through a healthcare facility. More particularly, embodiments may communicate the status of articles as they are moved throughout a facility to healthcare employees who may need the articles, or who may need to monitor their locations and status.

An example embodiment of the present invention may include a container defining a cavity, the container including an access detection system configured to detect when the cavity of the container is accessed, a radio frequency identification reader configured to be activated in response to the access detection system detecting that the cavity has been accessed, and a communications interface configured to transmit a signal identifying the contents of the cavity in response to the radio frequency identification reader identifying a change in contents of the cavity. The container may also include a lid movable between an open position in which the cavity is accessible, and a closed position in which the cavity is inaccessible, where the access detection system is configured to detect when the lid is moved to the open position. The radio frequency identification reader, when activated, is configured to read radio frequency identification tags disposed within the cavity. The container of example embodiments may include an electronic ink label, where the electronic ink label is configured to display identifying indicia corresponding to at least one item received within the cavity. The electronic ink label may be configured to change the identifying indicia that is displayed in response to the identification reader detecting a change in contents of the cavity. The electronic ink label may be configured to display a location destination for the at least one item received within the cavity.

According to some embodiments of the present invention, a location destination of an item received within the cavity of the container may be determined in response to the radio frequency identification reader reading the location destination information from the at least one item received within the cavity. The radio frequency identification reader may be configured to determine a location of the container. The communications interface may transmit a location of the container in response to the location of the container changing. Embodiments of the present invention may include a motion detector, wherein the radio frequency identification reader may be configured to be activated in response to the motion detector detecting motion meeting a predefined criterion.

Embodiments of the present invention may include a method of tracking an article including detecting that a cavity of a container has been accessed, reading one or more radio frequency identification tags of contents of the cavity of the container in response to detecting that the cavity has been accessed, and transmitting a signal identifying the contents of the cavity using a communications interface in response to the contents of the cavity changing. Detecting that a cavity of the container has been accessed may include detecting a lid of the container moving from a closed position in which the cavity is inaccessible to an open position in which the cavity is accessible. The method may include providing for display of identifying indicia corresponding to at least one item received within the cavity. Methods may include changing the identifying indicia provided for display in response to detecting a change in contents of the cavity. The identifying indicia may include a location destination corresponding to at least one item received within the cavity.

According to some embodiments of the present invention, methods may include determining a location of the container in response to reading a location-based radio frequency identification tag. Determining the location of the container may be initiated in response to detecting movement of the container meeting predefined criteria. Methods may include providing for transmission of the location of the container in response to the location of the container changing. Methods may include providing an alert in response to an item received within the cavity meeting a predefined criterion. The predefined criterion may include at least one of reaching an expiration date, reaching a threshold temperature, an item recall, or a change in status of an intended recipient.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates a container for controlling and tracking articles according to an example embodiment of the present invention;

FIG. 2 is a diagram of components of a container according to an example embodiment of the present invention;

FIG. 3 is a process sequence chart of an implementation using a container according to an example embodiment of the present invention;

FIG. 4 illustrates a container for controlling and tracking articles according to another example embodiment of the present invention; and

FIG. 5 is a flowchart of a method of implementation of a container according to example embodiments of the present invention.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from or send data to another computing device, it will be appreciated that the data may be received directly from or sent directly to another computing device, or may be received/sent indirectly via one or more intermediary computing devices, such as, for example, one or more servers, relays, routers, network access points, and/or the like.

Embodiments of the present invention may be used for storage and distribution, and control of access to articles, such as intravenous bags within a healthcare facility. Embodiments may be implemented in any environment in which it is desirable to store, monitor access of, control access of, and/or alert users of the arrival of an article, and/or to dispense articles from a storage location. Various solutions exist for the storage and dispensing of pharmaceuticals and medical supplies within a healthcare facility; however, intravenous bags provide additional challenges that need to be overcome for effective and efficient storage, tracking, and dispensing. For example, intravenous bags include non-structured packaging which can be difficult to use in automated dispensing systems. Further, the non-structured packaging may cause issues with conventional nurse carts due to their size, potential for punctures, and often refrigeration or temperature control requirements. As intravenous medications, particularly those with short shelf-lives or of costly medications, may be prepared on an as-needed basis, preparation and delivery of the intravenous medications may be particularly time-sensitive and may benefit from improvements in efficiency. Preparation, transport, delivery, and notification of the arrival of intravenous medications for a nurse may be a complex operation that consumes substantial time and may reduce both nurse efficiency and patient satisfaction in a healthcare facility. As such, it may be desirable to improve the efficiency of delivering and notifying a nurse of the arrival of an intravenous medication to eliminate the need for the nurse to search for an ordered intravenous medication.

Pharmaceuticals and medical supplies found in healthcare facilities may be costly and potentially hazardous if used improperly. Tracking such articles through a healthcare facility while efficiently and effectively dispensing the articles to a patient is a process that may be improved to reduce errors, increase accuracy, and improve the efficiency of dispensing to allow caregivers such as nurses to spend more time with patients in order to improve the patient experience in the healthcare facility. Notifying a healthcare employee, such as a nurse, of the arrival of a medication may be instrumental in reducing the amount of time spent by the healthcare employee tracking down medication that has been ordered. Further, improvements in tracking and delivery may reduce waste by eliminating lost medications thereby reducing operating costs of a healthcare facility.

According to embodiments of the present invention, radio frequency identification (RFID) tracking and monitoring of articles may be implemented to increase automation and improve the process of getting pharmaceuticals and medical supplies to a patient. While embodiments described herein describe an implementation of tracking and monitoring intravenous bags through a healthcare facility, embodiments may be implemented for tracking and monitoring various types of pharmaceuticals and supplies.

Embodiments of the present invention may include a container for receiving an intravenous (IV) bag, where the container may be used to monitor access to the container, monitor a location of the container, monitor the contents of the container, and to communicate information identifying the contents and location of the container to appropriate healthcare personnel.

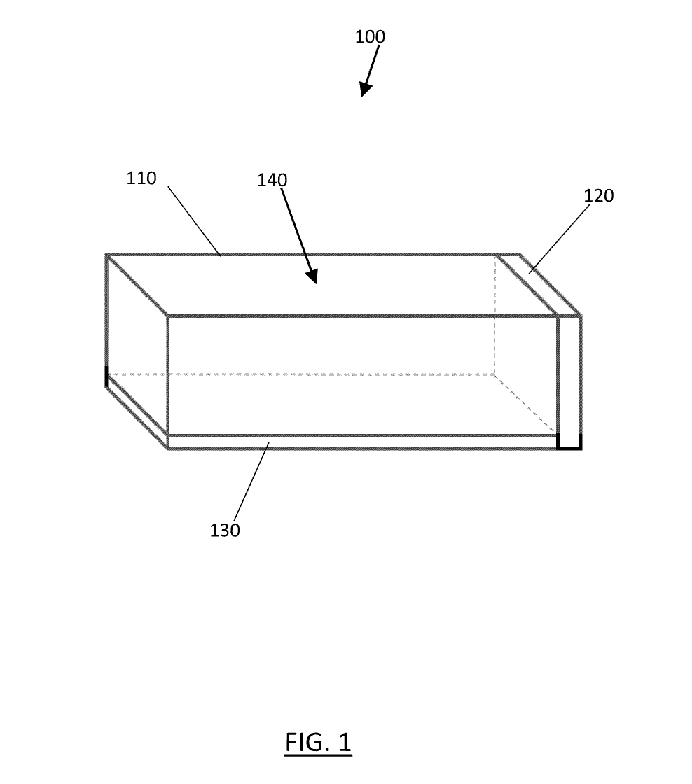

FIG. 1 illustrates an example embodiment of a container 100 according to the present invention. The illustrated container 100 includes container walls 110 that define a cavity 140 configured to receive articles therein. The container 100 includes a base 130 which may be configured such that multiple containers may be stacked on top of one another and may nest within each other for ease of storage. The base 130 may also include an antenna, such as an RFID antenna configured to read RFID tags as will be described further below. The illustrated embodiment of a container 100 further includes a compartment 120 configured to receive electronic components of the bin 100 as described further below. The compartment 120 of the illustrated embodiment of FIG. 1 is disposed along one of the walls 110 of the container 100. The remainder of the walls of the container may be transparent allowing a user to easily determine that the container 100 includes articles disposed in the cavity 140. Optionally, the walls 110 may be translucent and not transparent to allow a user to determine that there are articles contained within the cavity while masking the specific identities of the articles contained therein or labels disposed thereon for privacy. Housing electronic components of the bin 100 in the compartment 120 disposed along a single wall of the container may minimize obstruction of the view of the container provided by the transparent or translucent walls 110.

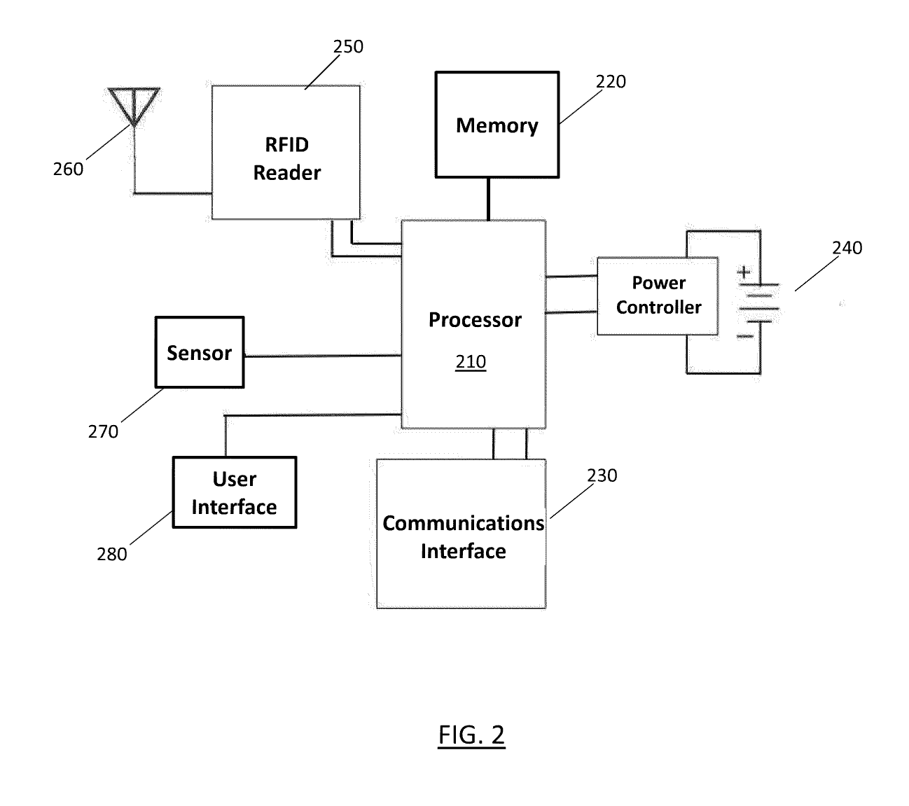

It will be appreciated that the container 100 of FIG. 1, as well as the illustrations in other figures, are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example of a configuration of a container implemented in a system for inventory tracking and control, numerous other configurations may also be used to implement embodiments of the present invention. Additional example embodiments may include a cavity that is virtually defined, where an RFID reader and antenna, together with the other components described below with respect to FIG. 2, may be disposed in a mat that is placed on a surface. The bounds of the mat may virtually define a cavity that can contain one or more pharmaceuticals or medical supplies as described herein.

FIG. 2 is a schematic illustration of components of a container according to an example embodiment of the present invention which includes various means for performing the various functions described herein. These means may include, for example, one or more of a processor 210, memory 220, communication interface 230, power source and controller 240, an RFID reader 250 including antenna 260, a sensor 270, and user interface 280 for performing the various functions described herein. The means of the system as described herein may be embodied as, for example, circuitry, hardware elements (e.g., a suitably programmed processor, combinational logic circuit, and/or the like), a computer program product comprising a computer-readable medium (e.g., memory 220) storing computer-readable program instructions (e.g., software or firmware) that are executable by a suitably configured processing device (e.g., the processor 210), or some combination thereof.

The processor 210 may, for example, be embodied as various means including one or more microprocessors, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 210 may comprise a plurality of processors. The plurality of processors may be embodied on a single computing device or may be distributed across a plurality of computing devices collectively configured to perform the functions of the container 100 described herein. The plurality of processors may be in operative communication with each other and may be collectively configured to perform one or more functionalities of the invention as described herein. In some embodiments, the processor 210 may be configured to execute instructions stored in the memory 220 or otherwise accessible to the processor 210. These instructions, when executed by the processor 210, may cause the container 100 to perform one or more of the functions as described herein. As such, whether configured by hardware or software methods, or by a combination thereof, the processor 210 may comprise an entity capable of performing operations according to embodiments of the present invention while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 220, the instructions may specifically configure the processor 210 to perform one or more algorithms and operations described herein.

The memory 220 may include, for example, volatile and/or non-volatile memory. Although illustrated in FIG. 2 as a single memory, the memory 220 may comprise a plurality of memories. The plurality of memories may be embodied on a single computing device or distributed across a plurality of computing devices. The memory 220 may comprise, for example, a hard disk, random access memory, cache memory, flash memory, an optical disc (e.g., a compact disc read only memory (CD-ROM), digital versatile disc read only memory (DVD-ROM), or the like), circuitry configured to store information, or some combination thereof. In this regard, the memory 220 may comprise any non-transitory computer readable storage medium. The memory 220 may be configured to store information, data, applications, instructions, and/or the like for enabling the container 100 to carry out various functions in accordance with example embodiments of the present invention. For example, in some example embodiments, the memory 220 is configured to buffer input data for processing by the processor 210. Additionally or alternatively, in some example embodiments, the memory 220 is configured to store program instructions for execution by the processor 210. The memory 220 may store information in the form of static and/or dynamic information. This stored information may be stored and/or used by the RFID reader 250 during the course of performing its functionalities.

In some example embodiments, the container 100 may include a communication interface(s), such as the communication interface 230. In embodiments including a communication interface, the communication interface 230 may be embodied as any device or means embodied in circuitry, hardware, a computer program product comprising a computer readable medium (e.g., the memory 220) storing computer readable program instructions executed by a processing device (e.g., the processor 210), or a combination thereof that is configured to receive and/or transmit data from/to another device with which the container 100 may be in communication. In some example embodiments, the communication interface 230 is at least partially embodied as or otherwise controlled by the processor 210. In this regard, the communication interface 230 may be in communication with the processor 210, such as via a bus. The communication interface 230 may additionally be in communication with the memory 220, user interface 230, and/or RFID reader 250, such as via a bus. The communication interface 230 may include, for example, an antenna, a transmitter, a receiver, a transceiver and/or supporting hardware or software for enabling communications with another computing device. The communication interface 230 may be configured to receive and/or transmit data using any protocol that may be used for communications between computing devices. As an example, the communication interface 230 may be configured to receive and/or transmit data from/to the RFID reader 250.

In some example embodiments, the container 100 may include a user interface 280. However, in other embodiments of the container 100, some aspects of the user interface 280 may be limited, or the user interface 280 may be omitted altogether. The user interface 280 may be in communication with the processor 210 to receive an indication of a user input and/or to provide an audible, visual, mechanical, or other output to a user. As such, the user interface 280 may include, for example, a keyboard, a mouse, a joystick, a display, a touch screen display, a microphone, a speaker, and/or other input/output mechanisms. The user interface 280 may be in communication with the memory 220, communication interface 230, and/or RFID reader 250, such as via a bus.

According to an example embodiment of a container according to the present invention, some or all of the components of FIG. 2 may be housed within compartment 120 of the container 100 shown in FIG. 1. As outlined above, placing the electronic components and processing circuitry in the compartment 120 may allow the container to retain transparent or translucent walls 110 to enable a user to detect contents of the container 100.

An implementation of a container according to example embodiments of the present invention is described herein with respect to the delivery and dispensing of a medication from the central pharmacy of a healthcare facility to a patient. The central pharmacy may receive an order for a medication, such as an IV medication, for a particular patient who is in a particular location. A pharmacist in the central pharmacy may verify and compound the medication upon receiving the medication order. A label may be generated for the medication based on the medication order. The label may include patient data (e.g., name, patient identification number, room number, a photo image of the patient, the medication type and dose, the prescribing physician, etc.) Some or all of this information may be printed to a label, such as by thermal printing, dot-matrix printing, ink-jet printing, or the like. The printed data may be human readable, and/or may include a barcode (e.g., a one or two dimensional barcode) in which the information is encoded or referenced. Further, according to an example embodiment, the label may include an RFID tag which is encoded with some or all of the label information. The RFID tag may be separate from, or integrated with the label. The label and RFID tag may be applied to the medication container, such as an IV bag, ready for delivery to a patient. A data record may be associated with each unique label. The data record may contain additional information about the intravenous medication including the lot code information, preparation information, administration instructions, etc. This record may be used to provide additional information to an electronic ink display, described below, to the nurse, or the information may be retrieved on demand, or retained in a data log together with time/location stamps to provide an audit trail of the medication throughout the healthcare facility.

The prepared and labeled IV bag may be delivered by a technician or an automated guided vehicle (AGV) to a location proximate the patient, such as a med room for the ward of the hospital where the patient is located. The labeled IV bag may be placed into a container 100 according to an example embodiment of the present invention. Optionally, the prepared and labeled IV bag may be placed into the container 100 at the central pharmacy by the pharmacist or the pharmacy technician. The container 100 may detect that the contents of the cavity have been accessed in response to receiving the labeled IV bag. For example, in one embodiment, the container 100 may include a motion sensor configured to detect the movement associated with receiving or removing contents from the cavity. In another example embodiment, the container may include a lid, where the container 100 may detect that the contents of the cavity have been accessed in response to the lid moving from a closed position, where the cavity is inaccessible, to an open position where the cavity is accessible. The motion sensor may be embodied as sensor 270 of FIG. 2 in communication with processor 210. Similarly, a sensor configured to detect a container lid opening may be embodied as sensor 270, which may include a proximity sensor, a plunger sensor, or any similar sensor which may detect the lid opening. Example embodiments may optionally include a plurality of sensors, such as a motion sensor to detect movement of the container suggesting a change in location, and another, separate sensor to detect the accessing of the cavity of the container.

In response to the container 100 detecting (e.g., via the processor 210) that the contents of the cavity 140 of the container 100 have been accessed, the RFID reader 250 may be activated. In order to preserve the life of the power source (e.g., battery 240), the RFID reader 250 may be dormant or inactive until the processor receives an indication that the cavity 140 of the container 100 has been accessed. The RFID reader 250 may be activated for a predetermined period of time after the detection of the contents of the cavity 140 being accessed, such as thirty seconds. The RFID reader may use antenna 260, which may, for example, be disposed on a wall 110 or bottom 130 of the container, or in an example embodiment including a lidded container, the antenna 260 may be integrated into the lid. The RFID reader may use multiple antennas in order to increase the probability of detecting a RFID tag in any orientation within the cavity.

Once the RFID reader 250 is activated, the antenna 260 is configured to detect RFID tags of articles within the cavity 140 of the container 100. The antenna 260 may be configured such that it is highly selective and reads only the contents of the cavity of the container 100 such that the contents of cavities of adjacent bins do not interfere or cause erroneous reading. In some example embodiments, the walls 110 of the container 100 may be configured to be radio-frequency shielded or attenuating to ensure that RFID tags in adjacent containers are not read by the RFID reader of another container.

While the above described embodiment includes only a single IV bag received within the cavity 140 of a container 100, embodiments may include multiple IV bags, IV bags and associated medical supplies (e.g., IV tubing, needles, etc.), or any other type of medication or supply, where each article received within the cavity may include an RFID tag and may be separately distinguishable by the RFID reader.

A location of the container 100 may also be established using a variety of available methods. For example, the RFID reader 250 of the container may be configured to read RFID location tags associated with storage locations within the healthcare facility. The RFID reader may utilize a separate antenna for reading RFID location tags. A med room may include one or more RFID tags that, when read by the RFID reader 250, establish a location of the container within the med room. Optionally, the container 100 may include an RFID tag and the RFID tag of the container may be read by RFID location beacons positioned throughout the healthcare facility to establish a location of the container. Other example methods of locating the container 100 may include using the communications interface 230 to establish a location of the container based upon the signal strength of a plurality of wireless communications access points. Location may be established in this manner by reading a wireless access point fingerprint which may be unique to the location of the container. Each of the aforementioned embodiments for establishing a location of the container 100 may be performed in response to the processor 210 of the container receiving an indication that the cavity 140 of the container has been accessed. Such a system would provide a location at the time when an article is received in, or removed from the container.

Optionally, the container 100 may include a motion sensor, which may be embodied as sensor 270. The container 100 may be configured to establish a location of the container in response to the motion sensor 270 detecting movement of the container. In this manner, each time the container is moved the location is established and may be reported as necessary, using communications interface 230. The degree of movement required for the container to establish its location may be above a particular threshold, such as an acceleration of more than one foot per second, for example. Movement can be detected by, for example, an accelerometer sensor. Only when the movement meets this criterion would the container establish a location. In another example embodiment, the container 100 may be configured to establish a location of the container periodically, such as every 5 minutes when the container includes an article disposed within the cavity (as determined by the RFID reader 250 outlined above), and less frequently, or not at all when the container does not include an article disposed therein.

Upon the RFID reader 250 reading the RFID tag of the article received within the cavity 140, and establishing a location of the container 100, the processor may cause a notification to be sent via the communications interface. The communications interface may be configured to communicate, for example, using the 802.11 standard with a network, such as a local area network (LAN) of the healthcare facility. The network of the healthcare facility may receive an indication of the specific article received at the container and update an inventory tracking and control system accordingly. Additionally, the network of the healthcare facility, or optionally, the communications interface 230 of the container 100 itself may send a notification to the appropriate healthcare employee, such as a nurse, notifying them of the arrival of the IV bag in the container 100 and the location of the container. In this manner, a nurse may not need to wait for their medications and may be alerted when their medications have arrived.

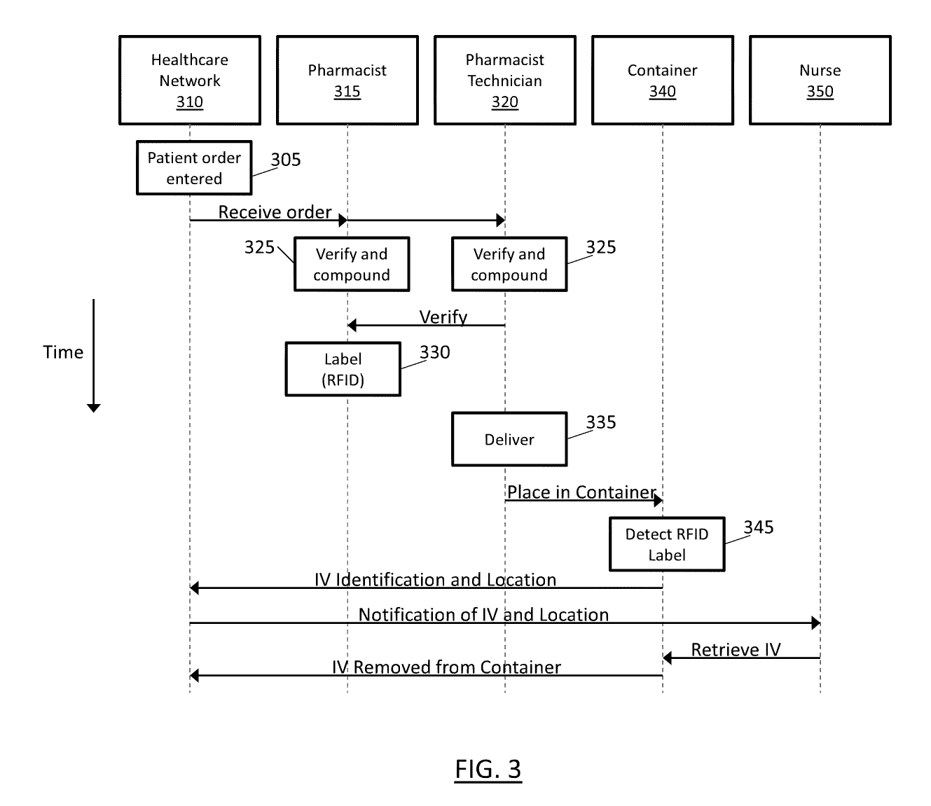

FIG. 3 illustrates a diagram of the example process sequence described above from receiving the medication order to retrieval of the medication by the nurse. The process, according to this example, begins at 305 where a medication order is entered into the healthcare network 310. The order is then transmitted to the central pharmacy where it is read by a pharmacist 315 and/or a pharmacist technician 320. The pharmacist or pharmacist technician may verify and compound the medication at 325. If the pharmacist technician compounds the medication, a verification step may occur from the pharmacist technician 320 to the pharmacist 315. The pharmacist or pharmacist technician may then apply a label, including an RFID tag, at 330 that is printed and encoded according to the medication order of 305. The pharmacist technician may then deliver the labeled IV bag at 335 and place it in container 340. Optionally, the pharmacist or pharmacist technician may place the labeled medication into a container at the central pharmacy, prior to delivery to a location where it will be accessed by a nurse. As described above, the container 340, using the processing circuitry of FIG. 2, detects the RFID label of the labeled IV bag at 345. The container 340 may then communicate (e.g., via communications interface 230) with the healthcare network 310 to provide an identification of the detected IV bag and the location of the container 340. In the illustrated embodiment of FIG. 3, a notification is sent from the healthcare network 310 to the nurse 350 providing an indication that the IV bag has arrived and providing the location of the IV bag and container 340. The nurse may then remove the IV bag from the container 340 and the container 340 may communicate with the healthcare network 310 to update the network as to the removal of the IV bag.

A notification may be provided to a healthcare employee, such as a nurse in a plurality of ways. For example, the notification may be generated by the network of the healthcare facility in response to the network receiving an indication of an arrival of a medication at a particular location. The healthcare facility network may then send a notification to the responsible healthcare employee, such as via wireless protocol, to a cell phone, pager, nurse cart, or the like. The notification may also be presented on a display, such as a display monitor at a nurse station, or a visible cue displayed proximate the location where the medication has arrived. The notification may alert the healthcare employee of the presence of the medication at a specific location such that the healthcare employee may retrieve the medication at their convenience, without having to search for or await the arrival of the medication. The notification may include any desired information about the medication, such as the medication type/dose, patient name, patient location, prescribed administration time, etc.

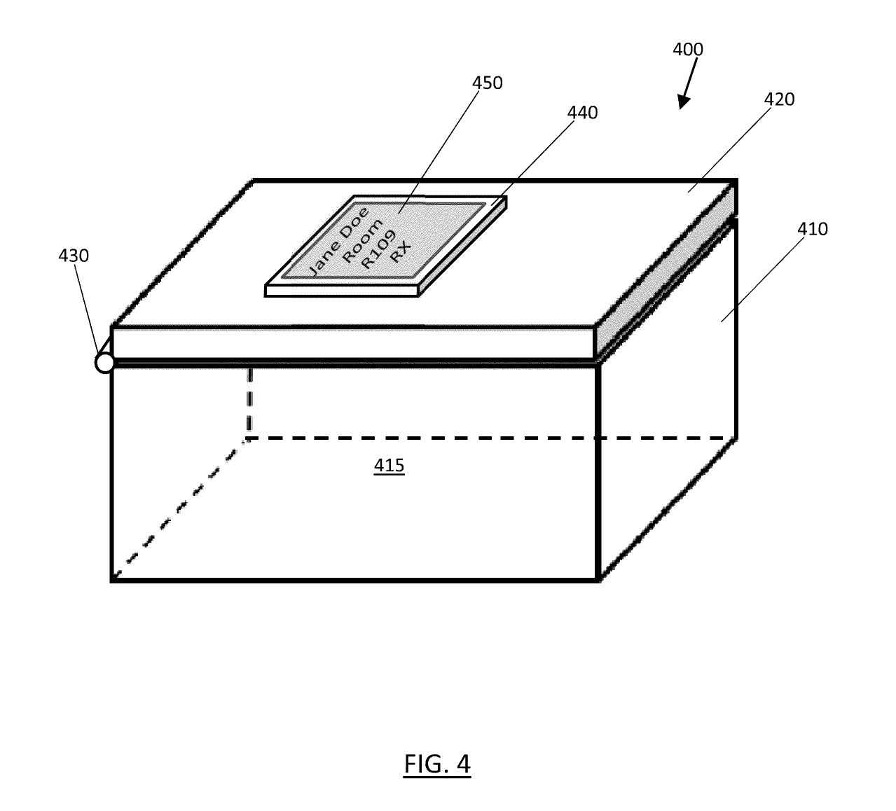

FIG. 4 illustrates another example embodiment of a container 400 according to the present invention. The illustrated embodiment includes a container base 410 and a container lid 420. The lid 420 may be moveable with respect to the base 410 between a closed position (as illustrated in FIG. 4) in which a cavity 415 of the container is inaccessible, and an open position in which the cavity 415 is accessible. The lid 420 may be entirely removable from the base 410, or the lid may be hingedly connected to the base, such as via hinge 430. The base 410 of the illustrated embodiment may define the cavity 415 and may be of a transparent or translucent material to allow a user to easily determine if the cavity 415 includes any articles. Contrary to the embodiment of FIG. 1, the base 410 of the container 400 including the side walls of the container may not include any of the electronic components of FIG. 2. Similarly, the bottom of the container 400 may not include any electronic components or an RFID antenna. In the illustrated embodiment of FIG. 4, all of the electronic components may be housed within the container lid 420. Further, the lid may be replaceable with respect to the container base 410 such that container bases which become cracked, worn, or otherwise unusable can be replaced, reusing an existing container lid 120 to save costs.

Example embodiments of the invention which include a lid may include a sensor, such as sensor 270 of FIG. 2, to detect when the lid is moved from the closed position to the open position. The lid sensor 460 of FIG. 4 may include a variety of types of sensors or switches that can detect the movement of the lid 420 to the open position. For example, the sensor 460 may be a plunger-type switch that is depressed when the lid 420 is closed to the container base 410. The sensor 460 may be a proximity sensor to detect the presence of the container base 410 in proximity to the sensor, indicating a closed position. The sensor 460 may also include a mercury-switch that detects when the lid 420 is raised at an angle indicating an open position.

While the illustrated embodiment of FIG. 4 may include all of the electronic components of FIG. 2 within the container lid 420, the embodiment of FIG. 4 includes an additional feature of a readable label 440, external to the container 400. The readable label 440 of the container 400 may be a user interface 280 as illustrated in FIG. 2 to provide information regarding the contents of the container 400. The readable label 440 may be an electronic display, such as a touch-screen, a liquid crystal diode (LCD) display, a light emitting diode (LED) display, or the like. In some embodiments, the readable label 440 may include an electronic ink label 450. One advantage to an electronic ink label is the low power consumption relative to an LED or LCD display.

The information presented on the readable label 440 may include a patient name, a patient location (e.g., hospital ward, room, etc.), identification information regarding the contents of the bin 400, expiration time/date of the contents of the bin, etc. The readable label 440 (e.g., user interface 280) may receive the information to be displayed from the processor 210, which may determine the information to be displayed in response to the RFID reader 250 reading the RFID tag of one or more articles received within the container 400. As such, the readable label 440 may automatically display information related to the contents of the container 400 in response to the container (e.g., the processor 210) detecting that the contents of the container have changed. A readable label may be configured to only present information in response to a stimulus. For example, a readable label 440 may be an electronic ink label which requires an external light source to be read (i.e., it may not be backlit like an LED display). The readable label 440 may include a photovoltaic cell configured to detect light and present the information on the readable label 440. In this manner, the readable label 440 is not presenting information when the label is not visible, and when the label is visible, the power may be supplied by the photovoltaic cell, thereby minimizing power consumption.

Example embodiments of the invention that include an enclosed cavity, such as the lidded embodiment of FIG. 4, may include controlled access to the cavity. For example, the lid 420 may include a latch or lock to lock the lid 420 to the container base 410. The lock may be unlocked in response to authentication of a user, such as a nurse. The nurse may authenticate themselves by a variety of means including biometric identification (e.g., fingerprints, retinal scan, palm scan, voice analysis, etc.), passcode entry (e.g., a personal identification number entered via the user interface 280), badge access (e.g., an employee identification badge scanned by RFID reader 250), or any combination thereof. Access to the cavity of the bin may only be granted in response to proper authentication of a user, thereby controlling access to the medication contained therein and providing an audit record of who accessed the medication and when.

Containers according to embodiments of the present invention may be configured to receive therein articles that have temperature control requirements, such as intravenous bags which are required to be kept below a threshold temperature. As such, containers may be configured to support temperature control in a variety of manners. For example, the containers of example embodiments may be configured to be received within refrigerated storage at a dispensing location. Optionally, the containers may be made of a material that can be pre-cooled, such as in a freezer, and maintain the cool temperature, such as with a container material that has a high thermal conductivity. In some embodiments, the container material may be a good insulator, with low thermal conductivity, and a cooling pack may be inserted into the cavity together with the article that is to remain cold. Further embodiments may include an active cooling pack that may be integrated with the electronic components of the container, or the active cooling pack may be a separate device that provides refrigeration to the container contents.

According to some embodiments of the present invention, the container 400 may further be configured to provide an alert in response to an article contained within the container meeting at least one of a predefined criteria, including expiration date, threshold temperature, a change in status of the patient for whom it's intended, etc. The information regarding a change in status of the patient for whom the article, such as an IV bag, is intended may be received via the communications interface 230 of the container 400 which may receive the information from a healthcare facility network. In an example embodiment, the discharge of a patient may cause a signal to be sent from the healthcare facility network to the bin to alert the nurse responsible for the patient that the medication is no longer needed. Alerts may be communicated via audible, visible, and/or tactile mechanisms.

Embodiments of the present invention may be configured to promote a relatively long battery life. The battery of example embodiments may include a rechargeable battery such as a lithium-ion battery. As described above, the RFID reader 250 may be configured to only be active temporarily in response to detection of access to the cavity of the container, suggesting a change in the contents of the container. This temporary activation may preserve and extend battery life. Further, as described above, a readable label 440 as a user interface 280 may use an electronic ink display to minimize power consumption. While power consumption may be minimized, a container 400 of example embodiments may be configured to alert a user when the battery has little life remaining The container 400 may include one or more light emitting diodes (LED) configured to alert a user of a low battery. The LED(s) may be disposed on a container lid 420 in the embodiment of FIG. 4, or the compartment 120 of FIG. 1. Containers may further be configured to send a low battery signal via the communications interface to a healthcare network such that a technician can replace the battery or recharge the container as necessary.

According to an example embodiment, the containers may be configured with an electronic connector, such as a docking connector or universal serial bus (USB) connector such that the containers can be docked for recharging. The containers may be docked and recharged in, for example, a pharmacy, a med room, or other location where the containers may be found when not being delivered.

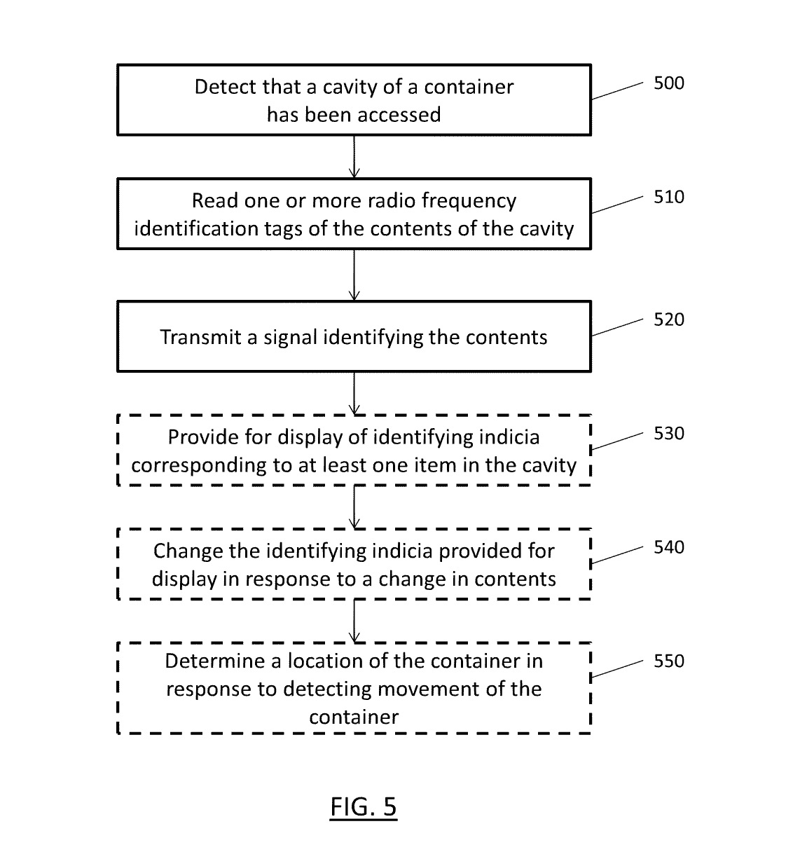

FIG. 5 illustrates a flowchart according to an example method for tracking an article according to some example embodiments. In this regard, FIG. 5 illustrates a method that may be at least partially performed by a container (e.g., container 100 of FIG. 1 or container 400 of FIG. 4). The operations illustrated in and described with respect to FIG. 5 may, for example, be performed by, with the assistance of, and/or under the control of one or more of the processor 210, memory 220, communication interface 230, user interface 280, or RFID reader 250. Operation 500 may include detecting that a cavity of a container has been accessed. This may be done by a motion sensor, a lid sensor, or a proximity sensor as outlined above, each of which may be represented by sensor 270 of FIG. 2. At 510, one or more radio frequency identification tags of the contents of the container may be read, such as by RFID reader 250. At 520, a signal may be transmitted identifying the contents of the container using, for example, communications interface 230.

Optionally, according to some embodiments of the invention, operation 530 may be performed to provide for display of identifying indicia corresponding to at least one item contained within the cavity. This may be provided for display on user interface 280 which may include, for example, an electronic ink display. Further, as illustrated at operation 540, the identifying indicia provided for display may be changed in response to a change in contents of the container. According to some embodiments of the invention, as illustrated at operation 550, a location of the container may be determined in response to detecting movement of the container, such as by sensor 270.

The flowchart of FIG. 5 illustrates a system, method, and computer program product according to example embodiments of the invention. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a server, desktop computer, laptop computer, mobile computer, or other computing device and executed by a processor (e.g., the processor 210) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks or steps of the flowchart support combinations of means for performing the specified functions and combinations of steps for performing the specified functions. It will also be understood that one or more blocks of the flowcharts, and combinations of blocks in the flowchart, may be implemented by special purpose hardware-based computer systems which perform the specified functions or steps, or combinations of special purpose hardware and computer program product(s).

The above described functions may be carried out in many ways. For example, any suitable means for carrying out each of the functions described above may be employed to carry out embodiments of the invention. In one embodiment, a suitably configured processor may provide all or a portion of the elements of the invention. In another embodiment, all or a portion of the elements of the invention may be configured by and operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A container defining a cavity, the container comprising:
an access detection system configured to detect when the cavity of the container is accessed;
a radio frequency identification reader, wherein the radio frequency identification reader is configured to be activated in response to the access detection system detecting that the cavity has been accessed; and
a communications interface configured to transmit a signal identifying contents of the cavity in response to the radio frequency identification reader identifying a change in contents of the cavity.

2. The container of claim 1, further comprising a lid movable between an open position in which the cavity is accessible, and a closed position in which the cavity is inaccessible, wherein the access detection system is configured to detect when the lid is moved to the open position.

3. The container of claim 1, wherein the radio frequency identification reader, when activated, is configured to read radio frequency identification tags disposed within the cavity.

4. The container of claim 1, further comprising an electronic ink label, wherein the electronic ink label is configured to display identifying indicia corresponding to at least one item received within the cavity.

5. The container of claim 4, wherein the electronic ink label is configured to change the identifying indicia that is displayed in response to the identification reader detecting a change in contents of the cavity.

6. The container of claim 4, wherein the electronic ink label is configured to display a location destination for the at least one item received within the cavity.

7. The container of claim 6, wherein the location destination for the at least one item received within the cavity is determined in response to the radio frequency identification reader reading the location destination information from the at least one item received within the cavity.

8. The container of claim 1, wherein the radio frequency identification reader is further configured to determine a location of the container.

9. The container of claim 8, wherein the communications interface transmits the location of the container in response to the location of the container changing.

10. The container of claim 1, further comprising a motion detector, wherein the radio frequency identification reader is configured to be activated in response to the motion detector detecting motion meeting a predefined criterion.

11. A method of tracking an article comprising:
detecting that a cavity of a container has been accessed;
reading one or more radio frequency identification tags of contents of the cavity of the container in response to detecting that the cavity has been accessed; and
transmitting a signal identifying the contents of the cavity using a communications interface in response to the contents of the cavity changing.

12. The method of claim 11, wherein detecting that a cavity of a container has been accessed comprises detecting a lid of the container moving from a closed position in which the cavity is in inaccessible, to an open position in which the cavity is accessible.

13. The method of claim 11, further comprising providing for display of identifying indicia corresponding to at least one item received within the cavity.

14. The method of claim 13, further comprising changing the identifying indicia provided for display in response to detecting a change in contents of the cavity.

15. The method of claim 13, wherein the identifying indicia comprises a location destination corresponding to at least one item received within the cavity.

16. The method of claim 15, further comprising determining a location of the container in response to reading a location-based radio frequency identification tag.

17. The method of claim 16, wherein determining the location of the container is initiated in response to detecting movement of the container meeting predefined criteria.

18. The method of claim 17, further comprising providing for transmission of the location of the container in response to the location of the container changing.

19. The method of claim 11, further comprising providing an alert in response to an item received within the cavity meeting a predefined criterion.

20. The method of claim 19, wherein the predefined criterion includes at least one of reaching an expiration date, reaching a threshold temperature, an item recall, or a change in status of an intended recipient.
